(19) United States
(12) Patent Application Publication
(10) Pub. No.: US 2024/0052908 A1
(43) Pub. Date: Feb. 15, 2024

(54) SHOCK ABSORBER

(71) Applicant: KYB Corporation, Tokyo (JP)

(72) Inventors: Takahisa MOCHIZUKI, Tokyo (JP); Takuhiro KONDO, Tokyo (JP)

(73) Assignee: KYB Corporation, Tokyo (JP)

(21) Appl. No.: 18/265,809

(22) PCT Filed: Dec. 10, 2021
(86) PCT No.: PCT/JP2021/047058

§ 371 Date: Jun. 7, 2023

(30) Foreign Application Priority Data
Feb. 12, 2021 (JP) 2021-020665
Feb. 12, 2021 (JP) 2021-020667

(51) Int. Cl. F16F 9/34

(52) U.S. Cl. CPC F16F 9/3405

(57) ABSTRACT

A shock absorber according to the present invention includes: a cylinder, a rod movably inserted into the cylinder, and a partition member having a disk shape and inserted into the cylinder to partition an inside of the cylinder into two working chambers, in which the partition member includes a plurality of ports that communicates the working chambers with each other, and a choke passage having a portion communicating the working chambers with each other and passing through an inner peripheral side or an outer peripheral side of each port along a circumferential direction.

### TECHNICAL FIELD

The present invention relates to a shock absorber.

### BACKGROUND ART

Some shock absorbers include, for example, a cylinder, a piston rod movably inserted into the cylinder, a piston slidably inserted into the cylinder and coupled to the piston rod, an extension side chamber and a compression side chamber that are defined in the cylinder by the piston and filled with hydraulic fluid, an extension side port and a compression side port that are provided in the piston and communicate the extension side chamber and the compression side chamber, an extension side leaf valve having an annular shape that is stacked on a compression side chamber side end of the piston, has an inner periphery fixed to the piston rod and an outer periphery allowed to bend, and opens and closes the extension side port, a compression side leaf valve having an annular shape that is stacked on an extension side chamber side end of the piston, has an inner periphery fixed to the piston rod and an outer periphery allowed to bend, and opens and closes the compression side port, and a choke passage that is provided in the piston and communicates the extension side chamber and the compression side chamber.

When the shock absorber configured as described above performs an extension and contraction operation at a low speed, the extension side leaf valve or the compression side leaf valve does not open, so that the hydraulic fluid flows back and forth between the extension side chamber and the compression side chamber through the choke passage. Therefore, as disclosed, for example, in JP 2007-132389 A, the conventional shock absorber exerts a damping force depending on a pressure loss when the hydraulic fluid passes only through the choke passage when performing an extension and contraction operation at a low speed. The characteristic of the damping force generated by the shock absorber with respect to the extension and contraction speed when the hydraulic fluid passes only through the choke passage (damping force characteristic) is a characteristic in which the damping force increases substantially in proportion to the extension and contraction speed, which is called a choke characteristic. Therefore, when the choke passage is provided in the piston as described above, the damping force is relatively easily set as compared with an orifice in which the damping force of the shock absorber has a characteristic proportional to the square of the extension speed.

### CITATION LIST

### Patent Literature

Patent Literature 1: JP 2007-132389 A

### SUMMARY OF INVENTION

### Technical Problem

Here, as the passage length of the choke passage increases, the resistance applied to the flow of the hydraulic fluid increases, and the damping force of the shock absorber can be increased. As described above, in the conventional shock absorber, when the choke passage is provided in the piston instead of the orifice, it is sufficient if the length of the choke passage is set according to the required damping force characteristic.

However, in the conventional shock absorber, when the choke passage is provided in the piston, it is provided to penetrate from an extension side chamber end to a compression side chamber end of the piston in an axial direction, and the length of the choke passage cannot be set to be equal to or longer than the length of the piston in the axial direction. In addition, since a stroke length of the shock absorber is sacrificed when the axial length of the piston is increased, there is a limit to increase the axial length of the piston.

As described above, the use of the orifice makes it difficult to set the damping force characteristic and thus it is desired to use the choke passage, but in the conventional shock absorber, since a long choke passage cannot be provided, there is a problem that the damping force when extending and contracting at a low speed cannot be set high.

Thus, an object of the present invention is to provide a shock absorber that can increase the damping force when extending and contracting at a low speed and enables easy setting of the damping force characteristic.

In order to solve the above problems, a shock absorber according to the present invention includes a cylinder, a rod movably inserted into the cylinder, and a partition member having a disk shape and inserted into the cylinder to define two working chambers in the cylinder, in which the partition member includes a port communicating the two working chambers, and a choke passage having a portion communicating the two working chambers and passing through an inner peripheral side or an outer peripheral side of the port of the partition member along a circumferential direction. In the shock absorber configured as described above, since the choke passage includes a portion provided along the circumferential direction in a dead space on the inner peripheral side or the outer peripheral side of the port of the partition member having a disk shape, the passage length of the choke passage can be increased without increasing the axial length of the partition member. Since the passage length of the choke passage can be increased, the degree of freedom in designing the passage length of the choke passage is improved, and a choke passage having a sufficient length can be formed in the partition member.

### BRIEF DESCRIPTION OF DRAWINGS

FIG. 1 is a longitudinal cross-sectional view of a shock absorber according to a first embodiment.

FIG. 2 is a plan view of a piston of the shock absorber according to the first embodiment.

FIG. 3 is an AA cross-sectional view of the piston of the shock absorber according to the first embodiment.

FIG. 4 is a bottom view of the piston of the shock absorber according to the first embodiment.

FIG. 5 is a cross-sectional view of a piston of a shock absorber according to a first modification of the first embodiment.

FIG. 6 is a cross-sectional view of a piston of a shock absorber according to a second modification of the first embodiment.

FIG. 7 is a longitudinal cross-sectional view of the shock absorber according to the first embodiment including a piston of a third modification.

FIG. 8 is a plan view of the piston of the shock absorber according to the third modification of the first embodiment.

FIG. 9 is a BB cross-sectional view of the piston of the shock absorber according to the third modification of the first embodiment.

FIG. 10 is a bottom view of the piston of the shock absorber according to the third modification of the first embodiment.

FIG. 11 is a plan view of a piston of a shock absorber according to a fourth modification of the first embodiment.

FIG. 12 is a cross-sectional view of a piston of a shock absorber according to a fifth modification of the first embodiment.

FIG. 13 is a longitudinal cross-sectional view of a shock absorber according to a second embodiment.

FIG. 14 is a plan view of a piston of the shock absorber according to the second embodiment.

FIG. 15 is an AA cross-sectional view of the piston of the shock absorber according to the second embodiment.

FIG. 16 is a bottom view of the piston of the shock absorber according to the second embodiment.

FIG. 17 is a cross-sectional view of a piston of a shock absorber according to a first modification of the second embodiment.

FIG. 18 is a cross-sectional view of a first member of a piston of a shock absorber according to a second modification of the second embodiment.

FIG. 19 is a cross-sectional view of a piston of a shock absorber according to a third modification of the second embodiment.

FIG. 20 is a longitudinal cross-sectional view of the shock absorber according to the second embodiment including a piston of a fourth modification.

FIG. 21 is a plan view of the piston of the shock absorber according to the fourth modification of the second embodiment.

FIG. 22 is a BB cross-sectional view of the piston of the shock absorber according to the fourth modification of the second embodiment.

FIG. 23 is a bottom view of the piston of the shock absorber according to the fourth modification of the second embodiment.

### DESCRIPTION OF EMBODIMENTS

### First Embodiment

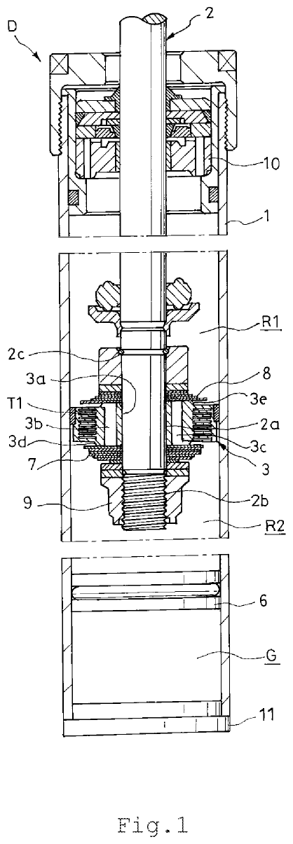

Hereinafter, the present invention will be described on the basis of embodiments illustrated in the drawings. As illustrated in FIG. 1, a shock absorber D according to the first embodiment includes a cylinder 1, a rod 2 movably inserted into the cylinder 1, and a piston 3, which is a partition member, that is inserted into the cylinder 1 and defines an extension side chamber R1 and a compression side chamber R2 as two working chambers in the cylinder 1. Further, in the case of the shock absorber D, for example, it is used by being interposed between a vehicle body and an axle of a vehicle, which is not illustrated, to suppress vibrations of the vehicle body and the wheels.

Each part of the shock absorber D will be described in detail below. As illustrated in FIG. 1, a rod guide 10 having an annular shape is mounted on an upper end of the cylinder 1, and a lower end of the cylinder 1 is closed by a cap 11. Further, in the cylinder 1, the rod 2 on which the piston 3 is mounted at a distal end is movably inserted.

The rod 2 is slidably inserted into the rod guide and inserted into the cylinder 1, and movement in the axial direction is guided by the rod guide 10. In addition, the inside of the cylinder 1 is partitioned by the piston 3 into the extension side chamber R1 and the compression side chamber R2 that are filled with fluid such as hydraulic fluid. Note that a liquid other than the hydraulic fluid such as water and an aqueous solution may also be used as the fluid. In addition, the fluid may be a gas instead of a liquid.

Note that a gas chamber G is defined inside the cylinder 1 below the compression side chamber R2 by a free piston 6 slidably inserted into the cylinder 1. Further, when the rod 2 is displaced in the axial direction with respect to the cylinder 1, the gas chamber G is expanded or contracted by the free piston 6 being displaced in the axial direction with respect to the cylinder 1 according to the volume of the rod 2 entering and leaving the cylinder 1, and the volume of the rod 2 entering and leaving the cylinder 1 is compensated by a change in the volume of the gas chamber G. In this manner, the shock absorber D is a so-called single cylinder type shock absorber, but may be configured as a double cylinder type shock absorber including a reservoir outside the cylinder 1.

Returning to this, the rod 2 includes a screw portion 2b provided on the outer periphery of a distal end portion 2a, which is a lower end in FIG. 1, and a C-ring 2c attached to the outer periphery above the distal end portion 2a. An extension side leaf valve 7 and a compression side leaf valve 8 formed in an annular shape are attached to the outer periphery of the distal end portion 2a of the rod 2 together with the piston 3 having an annular shape. The leaf valves 7 and 8 and the piston 3 are sandwiched between a piston nut 9 screwed to the screw portion 2b and the C-ring 2c and fixed to the outer periphery of the distal end portion 2a of the rod 2.

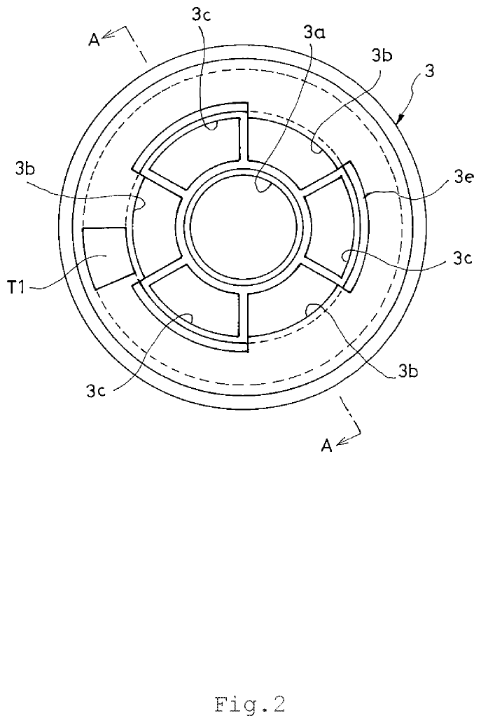

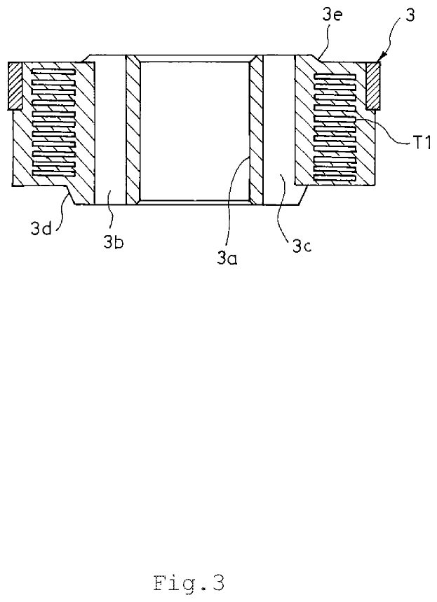

As illustrated in FIGS. 2 to 4, the piston 3 has a disk shape, and includes an insertion hole 3a through which the distal end portion 2a of the rod 2 is inserted at the center, and extension side ports 3b and compression side ports 3c that are provided on the same circumference and have an arc shape as viewed in the axial direction. In addition, three extension side ports 3b and three compression side ports 3c are alternately arranged on the same circumference in the piston 3, and serve as ports in the piston 3, which is a partition member.

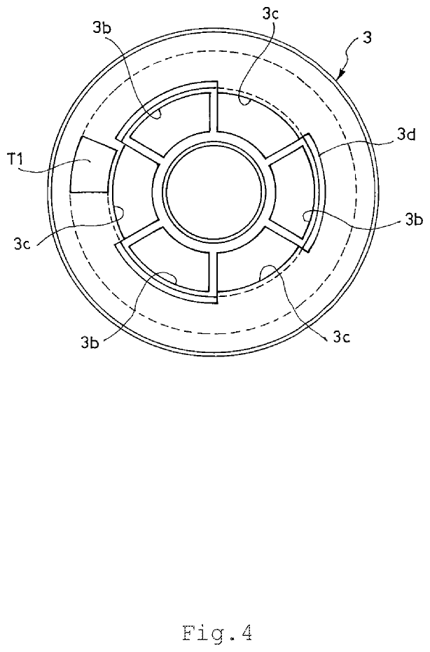

In addition, the piston 3 includes a valve seat 3d having a petal shape surrounding each extension side port 3b at an end portion facing the compression side chamber R2 side as illustrated in FIG. 4, and a valve seat 3e having a petal shape surrounding each compression side port 3c at an end portion facing the extension side chamber R1 side as illustrated in FIG. 2. As described above, the extension side ports 3b provided in the piston 3 of the shock absorber D of the first embodiment are independent opening ports that do not communicate with each other, and the compression side ports 3c are also independent opening ports that do not communicate with each other.

Further, as illustrated in FIGS. 2 to 4, the piston 3 includes a choke passage T1 having a spiral shape disposed on the outer peripheral side of the extension side ports 3b and the compression side ports 3c of the piston 3 and surrounding the extension side ports 3b and the compression side ports 3c. That is, the choke passage T1 is formed in a spiral shape and is formed to include a spiral portion passing through the outer peripheral side of the extension side ports 3b and the compression side ports 3c, which are the ports of the piston 3, along the circumferential direction. More in detail, the choke passage T1 has a spiral shape and opens from the outer peripheral side of the valve seat 3e at the extension side chamber R1 side end of the piston 3 to the outer peripheral side of the valve seat 3d at the compression side chamber R2 side end of the piston 3 and communicates the extension side chamber R1 and the compression side chamber R2.

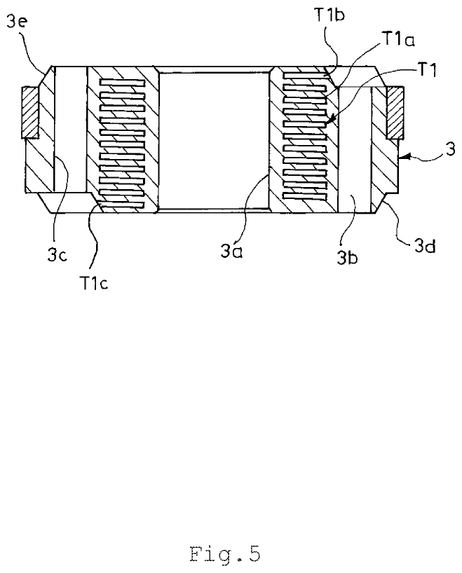

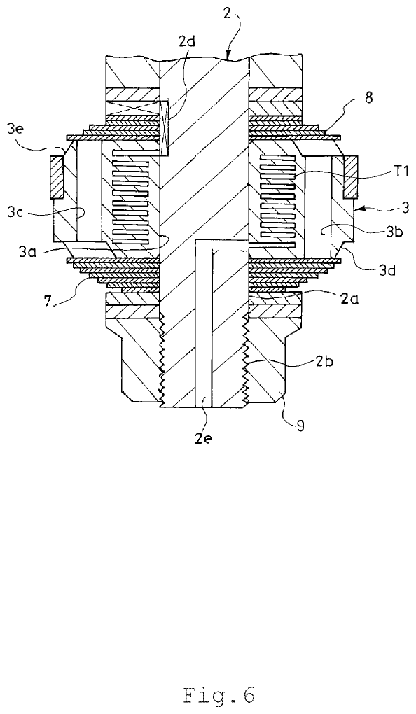

Note that, although not illustrated, the choke passage T1 may include a spiral portion disposed on the outer peripheral side of the extension side ports 3b and the compression side ports 3c of the piston 3, a portion that opens in the axial direction from the outer peripheral side of the valve seat 3e at the extension side chamber R1 side end of the piston 3 and is connected to the spiral portion, and a portion that opens in the axial direction from the outer peripheral side of the valve seat 3d at the compression side chamber R2 side end of the piston 3 and is connected to the spiral portion. In addition, the choke passage T1 having a spiral shape may be disposed on the inner peripheral side of the extension side ports 3b and the compression side port 3c of the piston 3 as in pistons 3 of the first modification illustrated in FIG. 5 and the second modification illustrated in FIG. 6. When the choke passage T1 is disposed on the inner peripheral side of the extension side ports 3b and the compression side port 3c of the piston 3, as illustrated in FIG. 5, it is sufficient if a spiral portion T1a of the choke passage T1 is provided such that portions T1b and T1c that communicate respectively with the extension side chamber R1 side end and the compression side chamber R2 side end of the piston 3 are provided between the extension side ports 3b and the compression side ports 3c of the piston 3. In addition, when the choke passage T1 is disposed on the inner peripheral side of the extension side ports 3b and the compression side ports 3c of the piston 3, as illustrated in FIG. 6, one end and an other end of the choke passage T1 may be opened to the insertion hole 3a, and the rod 2 may be provided with a passage 2d in which one opening communicates with the extension side chamber R1 and a passage 2e in which the other opening communicates with the compression side chamber R2.

Note that the piston 3 configured as described above can be manufactured using a 3D printer. When the 3D printer is used, the choke passage T1 having a complicated structure can be easily formed in the piston 3 together with the extension side ports 3b and the compression side ports 3c.

The extension side leaf valve 7 is a stack leaf valve in which a plurality of annular plates is stacked, and is stacked on a lower surface of the piston 3 facing the compression side chamber R2 in FIG. 1. The inner periphery of the extension side leaf valve 7 is sandwiched and fixed between the piston nut 9 and the C-ring 2c, bending of the outer peripheral side, which is a free end, is allowed, and the extension side leaf valve 7 is seated and unseated with respect to the valve seat 3d to open and close outlet ends of the extension side ports 3b. As described above, when the extension side leaf valve 7 is placed on the piston 3, sandwiched between the piston nut 9 and the C-ring 2c of the rod 2, and fixed to the rod 2, the extension side leaf valve 7 abuts on the valve seat 3d and is stacked on the piston 3. Further, in a state where the outer periphery is seated on the valve seat 3d, the extension side leaf valve 7 closes the extension side ports 3b and disconnects communication between the extension side chamber R1 and the compression side chamber R2 via the extension side ports 3b. In addition, when the extension side leaf valve 7 is bent by receiving a pressure of the extension side chamber R1 through the extension side ports 3b and unseated from the valve seat 3d, the extension side ports 3b are opened, the extension side chamber R1 and the compression side chamber R2 communicate with each other, and resistance is applied to the flow of the hydraulic fluid from the extension side chamber R1 to the compression side chamber R2.

In addition, the compression side leaf valve 8 is a stack leaf valve in which a plurality of annular plates is stacked, and is stacked on an upper surface of the piston 3 facing the extension side chamber R1 in FIG. 1. The inner periphery of the compression side leaf valve 8 is sandwiched and fixed between the piston nut 9 and the C-ring 2c, bending of the outer peripheral side, which is a free end, is allowed, and the compression side leaf valve 8 is seated and unseated with respect to the valve seat 3e to open and outlet ends of the compression side ports 3c. As described above, when the compression side leaf valve 8 is placed on the piston 3, sandwiched between the piston nut 9 and the C-ring 2c of the rod 2, and fixed to the rod 2, the compression side leaf valve 8 abuts on the valve seat 3e and is stacked on the piston 3. Further, in a state where the outer periphery is seated on the valve seat 3e, the compression side leaf valve 8 closes the compression side ports 3c and disconnects communication between the compression side chamber R2 and the extension side chamber R1 via the compression side ports 3c. In addition, when the compression side leaf valve 8 is bent by receiving a pressure of the compression side chamber R2 through the compression side ports 3c and unseated from the valve seat 3e, the compression side ports 3c are opened, the compression side chamber R2 and the extension side chamber R1 communicate with each other, and resistance is applied to the flow of the hydraulic fluid from the compression side chamber R2 to the extension side chamber R1.

The shock absorber D is configured as described above, and the operation of the shock absorber D will be described hereinafter. First, an operation when the rod 2 moves upward in FIG. 1 with respect to the cylinder 1 and the shock absorber D performs an extension operation will be described. When the shock absorber D performs the extension operation, the piston 3 moves upward in FIG. 1 with respect to the cylinder 1, and thus, the extension side chamber R1 is compressed and the compression side chamber R2 is enlarged.

Then, the pressure in the extension side chamber R1 increases. This pressure acts on the extension side leaf valve 7 through the extension side ports 3b that are not closed by the leaf valve 8 stacked on the upper end of the piston 3 in FIG. 1. When the extension speed of the shock absorber D is low and the pressure in the extension side chamber R1 does not reach the valve opening pressure of the leaf valve 7, the hydraulic fluid moves from the extension side chamber R1 to the compression side chamber R2 only through the choke passage T1. Therefore, when the extension speed is low, the choke passage T1 applies resistance to the hydraulic fluid passing therethrough and the shock absorber D generates a damping force. In addition, when the extension speed of the shock absorber D exceeds the low speed and reaches the high speed range, the leaf valve 7 bends and is unseated from the valve seat 3d to open the extension side ports 3b, so that the hydraulic fluid in the extension side chamber R1 passes through the extension side ports 3b and the choke passage T1 and moves to the compression side chamber R2. When the flow rate increases, the choke passage T1 applies a larger resistance to the flow of the hydraulic fluid than the leaf valve 7 does. Therefore, when the extension speed of the shock absorber D becomes high, the hydraulic fluid is less likely to pass through the choke passage T1, so that the hydraulic fluid preferentially passes through the extension side ports 3b. Therefore, when the extension speed exceeds the low speed and reaches the high speed range, the shock absorber D generates a damping force substantially by the resistance applied to the flow of the hydraulic fluid by the leaf valve 7. Note that at the time of extension of the shock absorber D, since the rod 2 is retracted from the inside of the cylinder 1, the free piston 6 moves upward in FIG. 1 with respect to the cylinder 1, the volume of the gas chamber G is enlarged by the volume of the rod 2 retracted from the inside of the cylinder 1, and the volume of the rod 2 retracted from the inside of the cylinder 1 is compensated.

Next, an operation when the rod 2 moves downward in FIG. 1 with respect to the cylinder 1 and the shock absorber D performs a contraction operation will be described. When the shock absorber D performs the contraction operation, the piston 3 moves downward in FIG. 1 with respect to the cylinder 1, and thus, the compression side chamber R2 is compressed, and the extension side chamber R1 is enlarged.

Then, the pressure in the compression side chamber R2 increases. This pressure acts on the compression side leaf valve 8 through the compression side ports 3c that are not closed by the leaf valve 7 stacked on the lower end of the piston 3 in FIG. 1. When the contraction speed of the shock absorber D is low and the pressure in the compression side chamber R2 does not reach the valve opening pressure of the leaf valve 8, the hydraulic fluid moves from the compression side chamber R2 to the extension side chamber R1 only through the choke passage T1. Therefore, when the contraction speed is low, the choke passage T1 applies resistance to the hydraulic fluid passing therethrough and the shock absorber D generates a damping force. In addition, when the contraction speed of the shock absorber D exceeds the low speed and reaches the high speed range, the leaf valve 8 bends and is unseated from the valve seat 3e to open the compression side ports 3c, so that the hydraulic fluid in the compression side chamber R2 passes through the compression side ports 3c and the choke passage T1 and moves to the extension side chamber R1. When the flow rate increases, the choke passage T1 applies a larger resistance to the flow of the hydraulic fluid than the leaf valve 8 does. Therefore, when the contraction speed of the shock absorber D becomes high, the hydraulic fluid is less likely to pass through the choke passage T1, so that the hydraulic fluid preferentially passes through the compression side ports 3c. Therefore, when the contraction speed exceeds the low speed and reaches the high speed range, the shock absorber D generates a damping force substantially by the resistance applied to the flow of the hydraulic fluid by the leaf valve 8. Note that at the time of contraction of the shock absorber D, since the rod 2 enters the inside of the cylinder 1, the free piston 6 moves downward in FIG. 1 with respect to the cylinder 1, the volume of the gas chamber G is reduced by the volume of the rod 2 entering the inside of the cylinder 1, and the volume of the rod 2 entering the inside of the cylinder 1 is compensated.

As described above, when the extension and contraction speed of the shock absorber D is low, the shock absorber D generates a damping force with the choke passage T1, and when the extension and contraction speed of the shock absorber D is high, the shock absorber D generates a damping force with the leaf valves 7 and 8. Therefore, the damping force characteristic of the shock absorber D of the first embodiment is a characteristic that becomes the choke characteristic substantially proportional to the extension and contraction speed when the extension and contraction speed of the shock absorber D is low and changes to the valve characteristic of the leaf valves 7 and 8 when the extension and contraction speed of the shock absorber D is high.

As described above, the shock absorber D of the first embodiment includes the cylinder 1, the rod 2 movably inserted into the cylinder 1, and the piston (partition member) 3 that has a disk shape and is inserted into the cylinder 1 to partition the inside of the cylinder 1 into the extension side chamber R1 and the compression side chamber R2 as the two working chambers, and the piston (partition member) 3 includes the extension side ports (ports) 3b and the compression side ports (ports) 3c that communicate the extension side chamber R1 and the compression side chamber R2, and the choke passage T1 that includes a portion communicating the extension side chamber R1 and the compression side chamber R2 and passing through the outer peripheral side of the extension side ports (ports) 3b and the compression side ports (ports) 3c of the piston (partition member) 3 along the circumferential direction.

In the shock absorber D configured as described above, since the choke passage T1 includes a portion provided along the circumferential direction in a dead space of the outer periphery of the extension side ports (ports) 3b and the compression side ports (ports) 3c of the piston (partition member) 3 having a disk shape, the passage length of the choke passage T1 can be increased without increasing the axial length of the piston (partition member) 3. Since the passage length of the choke passage T1 can be increased, the degree of freedom in designing the passage length of the choke passage T1 is improved, and the choke passage T1 having a sufficient length can be formed in the piston (partition member) 3. As described above, with the shock absorber D of the first embodiment, the passage length of the choke passage T1 can be increased, and it is not necessary to use an orifice the damping force characteristic of which is difficult to set as a countermeasure for the insufficient damping force, and therefore, the damping force at the time of extension and contraction at a low speed can be increased, and the damping force characteristic can be easily set.

Note that, in the choke passage T1, as described above, since the choke passage T1 may include a portion provided along the circumferential direction in a dead space of the inner periphery of the extension side ports (ports) 3b and the compression side ports (ports) 3c of the piston (partition member) 3 having a disk shape. Also with the shock absorber D configured as described above, the passage length of the choke passage T1 can be increased, and it is not necessary to use an orifice the damping force characteristic of which is difficult to set as a countermeasure for the insufficient damping force, and therefore, the damping force at the time of extension and contraction at a low speed can be increased, and the damping force characteristic can be easily set.

In addition, with the shock absorber D of the first embodiment, since the portion provided in the inner periphery or the outer periphery of the extension side ports (ports) 3b and the compression side ports (ports) 3c of the piston (partition member) 3 in the choke passage T1 has a spiral shape, the length of the choke passage T1 can be set by setting the number of times of circulating the inside of the piston (partition member) 3 in the circumferential direction by effectively using the dead space of the piston (partition member) 3, and the degree of freedom in designing the passage length of the choke passage T1 can be greatly improved.

Note that, in the shock absorber D of the first embodiment, the partition member is the piston 3, but a partition wall or the like used in a manner of being fixed to the cylinder 1 may be used as the partition member. For example, in a double cylinder type shock absorber including a reservoir outside the cylinder, a valve case fixed to an end portion of the cylinder may be used as a partition member, the reservoir and a compression side chamber partitioned by the valve case may be used as working chambers, and a choke passage may be formed in the valve case.

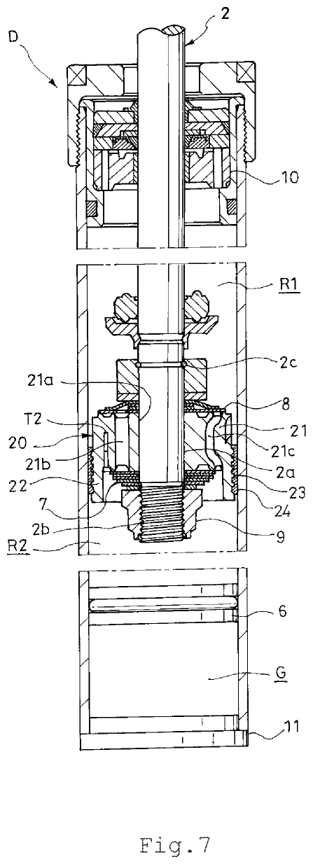

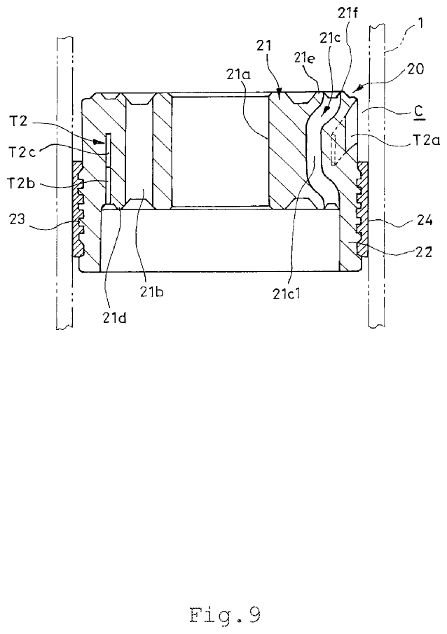

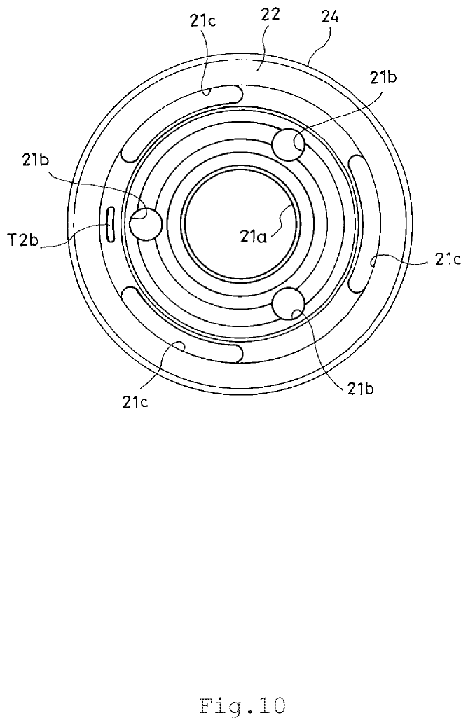

In addition, as illustrated in FIG. 7, a piston 20 may be configured as described below as a third modification of the partition member. As illustrated in FIGS. 7 to 10, the piston 20 includes a piston main body 21 having a disc shape and including an insertion hole 21a that allows insertion of the rod 2 at the center, an extension portion 22 having a cylindrical shape suspended from an outer periphery of a lower end of the piston main body 21 in FIG. 9, a ring mounting portion 23 having a plurality of annular grooves provided on an outer periphery of the extension portion partway on the outer periphery of the piston main body 21, and a piston ring 24 mounted on the outer periphery of the ring mounting portion 23. In the piston 20 configured as described above, the outer diameter of the portion of the piston main body 21 where the piston ring 24 is not mounted is smaller than the outer diameter of the piston ring 24, and an annular gap C is formed between this portion and the cylinder 1. That is, a small-diameter portion 25 is formed in the piston 20 at the portion of the piston main body 21 where the piston ring 24 is not mounted.

In addition, the piston main body 21 of the piston 20 includes three compression side ports 21c that communicate the extension side chamber R1 and the compression side chamber R2 and have an arc shape as viewed in the axial direction, and three extension side ports 21b, which are second ports, that communicate the extension side chamber R1 and the compression side chamber R2 and have a circular shape as viewed in the axial direction. The extension side ports 21b are provided at equal intervals on the same circumference of the piston main body 21 of the piston 20, and the compression side ports 21c are provided at equal intervals on the same circumference on the outer peripheral side of the extension side ports 21b of the piston main body 21 of the piston 20. Further, an extension side annular valve seat 21d surrounding the outer peripheral side of each extension side port 21b is provided at the compression side chamber R2 side end of the piston main body 21, and an inner annular valve seat 21e provided between the extension side ports 21b and the compression side ports 21c and surrounding the outer peripheral side of each extension side port 21b and a compression side annular valve seat 21f surrounding the outer peripheral side of each compression side port 21c are provided at the extension side chamber R1 side end of the piston main body 21.

The extension side ports 21b and the compression side ports 21c are provided at positions displaced from each other in the circumferential direction with respect to the piston main body 21, that is, at positions not aligned in a radial direction with respect to the piston main body 21. Furthermore, as illustrated in FIG. 9, the compression side port 21c provided on the outer peripheral side of the extension side port 21b with respect to the piston main body 21 includes a bent portion 21c1 bent toward the inner peripheral side of the piston main body 21 at the center.

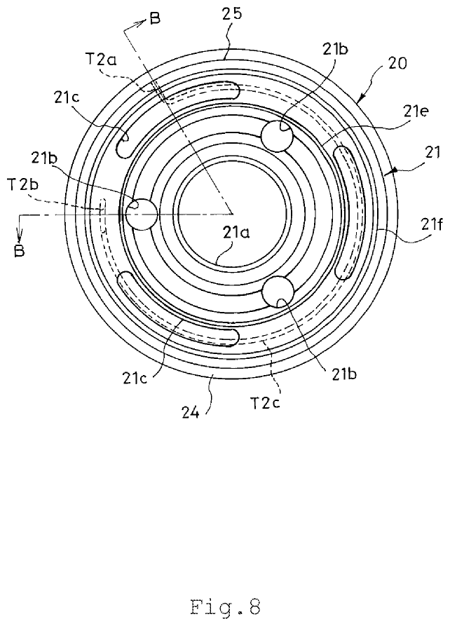

Further, the piston 20 is provided with a choke passage T2. The choke passage T2 is configured to include a portion T2a that opens from the small-diameter portion 25 that is the outer periphery of the piston main body 21, extends obliquely downward in FIG. 9 and in the direction of the center of the piston 20, and reaches the center of the piston main body 21 in the axial direction, a portion T2b that opens from a position that is a lower end of the piston main body 21 in FIG. 9, is an outer periphery of the openings of the extension side ports 21b, and faces the extension side ports 21b in the radial direction, extends in the axial direction, and reaches the center of the piston main body 21 in the axial direction, and a portion T2c that is disposed on the outer peripheral side of the compression side ports 21c that are ports and the extension side ports 21b that are second ports in the piston 20, passes along the circumferential direction, and communicates the portion T2a and the portion T2b as illustrated in FIG. 8. Note that the circumferential length of the portion T2c is set to be longer than the axial length of the piston main body 21 of the piston 20, but can be set to any length according to the setting of the damping force. In addition, the portion T2c may extend along the circumferential direction while meandering in the radial direction of the piston main body 21.

The portion T2c of the choke passage T2 passing through the outer peripheral side of the compression side ports 21c and the extension side ports 21b of the piston 20 along the circumferential direction passes through the outside of the bent portions 21c1 of the compression side ports 21c, and is disposed at a position overlapping the open ends of the compression side ports 21c when the piston 20 is viewed from the axial direction as illustrated in FIG. 8. That is, the portion T2c of the choke passage T2 is disposed in the outer periphery of the bent portions 21c1 of the compression side ports 21c and on the side opposite to the bent side of the bent portions 21c1, and is disposed between the openings of the compression side ports 21c on the extension side chamber R1 side and the openings on the compression side chamber R2 side in the axial direction of the piston 20. From the viewpoint of the compression side ports 21c, the compression side ports 21c include the bent portions 21c1 that avoid the portion T2c of the choke passage T2 at the center.

As described above, since the compression side ports 21c include the bent portions 21c1 partway, a space for providing the portion T2c passing through the outer peripheral side of the compression side ports 21c along the circumferential direction of the choke passage T2 is formed on the outer peripheral side of the bent portions 21c1 of the piston 20, and the choke passage T2 can be formed in the piston 20 without difficulty. Note that since each extension side port 21b, which is a second port, is provided on the inner peripheral side of each compression side port 21c, it is not necessary to provide a bent portion in order to secure a space for providing the portion T2c of the choke passage T2. Note that when a space for providing the portion T2c of the choke passage T2 cannot be secured in the piston 3 without the bent portions because the compression side ports 21c and the extension side ports 21b are provided on the same circumference, the compression side ports 21c and the extension side ports 21b may be provided with the bent portions.

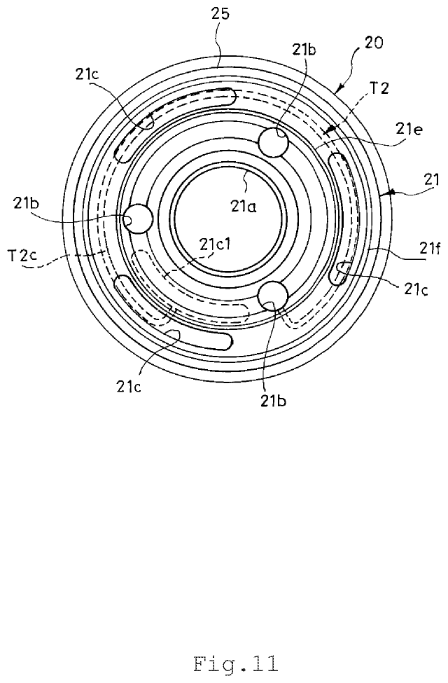

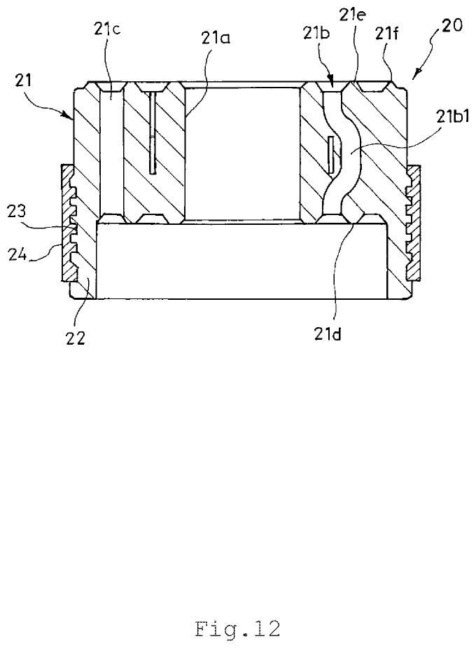

In addition, the choke passage T2 may be formed as in a piston 20 of a fourth modification illustrated in FIG. 11 and a fifth modification illustrated in FIG. 12. Specifically, the choke passage T2 includes only the portion T2c, and as illustrated in FIG. 11, the compression side ports 21c and the extension side ports 21b communicate with each other in the piston 3, and the extension side chamber R1 and the compression side chamber R2 communicate with each other via the compression side ports 21c and the extension side ports 21b. Furthermore, as illustrated in FIG. 12, the portion T2c of the choke passage T2 may be disposed on the inner peripheral side of the extension side ports 21b and the compression side ports 21c of the piston 20. In this case, a space for providing the portion T2c may be secured by providing bent portions 21b1 bent toward the outer peripheral side of the piston 20 using the extension side ports 21b as ports so that the extension side ports 21b on the inner peripheral side do not compress the space for providing the portion T2c of the choke passage T2, and the bent portions may not be provided for the compression side ports 21c. Note that when the choke passage T2 is disposed on the inner peripheral side of the extension side ports 21b and the compression side ports 21c of the piston 20, similarly to the example illustrated in FIG. 6, one end and an other end of the choke passage T2 may be opened to the insertion hole 21a, and the rod 2 may be provided with a passage 2d in which one opening communicates with the extension side chamber R1 and a passage 2e in which the other opening communicates with the compression side chamber R2.

Even when the choke passage T2 is formed in the piston 20 as described above, since the choke passage T2 includes the portion provided along the circumferential direction in the dead space on the outer peripheral side of the compression side ports (ports) 21c of the piston (partition member) 20 having a disk shape, the passage length of the choke passage T2 can be increased along the circumferential direction in which the length can be easily obtained as compared with the axial length of the piston (partition member) 20 without increasing the axial length of the piston (partition member) 20. Since the passage length of the choke passage T2 can be increased, the degree of freedom in designing the passage length of the choke passage T2 is improved, and the choke passage T2 having a sufficient length can be formed in the piston (partition member) 20. Therefore, with the shock absorber D of the first embodiment in which the choke passage T2 is formed in the piston 20 as described above, the passage length of the choke passage T2 can be increased, and it is not necessary to use an orifice the damping force characteristic of which is difficult to set as a countermeasure for the insufficient damping force, and therefore, the damping force at the time of extension and contraction at a low speed can be increased, and the damping force characteristic can be easily set.

Note that, in the choke passage T2, as described above, the choke passage T2 may include a portion provided along the circumferential direction in a dead space on the inner peripheral side of the compression side ports (ports) 21c of the piston (partition member) 20 having a disk shape. Also with the shock absorber D configured as described above, the passage length of the choke passage T2 can be increased, and it is not necessary to use an orifice the damping force characteristic of which is difficult to set as a countermeasure for the insufficient damping force, and therefore, the damping force at the time of extension and contraction at a low speed can be increased, and the damping force characteristic can be easily set.

In addition, in the piston (partition member) 20 of the third modification described above, the compression side ports (ports) 21c include the bent portions 21c1 that bend to the inner periphery of the piston (partition member) 20, and the portion T2c of the choke passage T2 that is disposed on the outer peripheral side of the compression side ports (ports) 21c of the piston (partition member) 20 and passes along the circumferential direction is disposed on the outer peripheral side of the bent portions 21c1 of the compression side ports (ports) 21c and on the side opposite to the bent side of the bent portions 21c1. With the shock absorber D configured as described above, a space for providing the portion T2c passing through the outer peripheral side of the compression side ports (ports) 21c along the circumferential direction of the choke passage T2 is formed on the outer peripheral side of the bent portions 21c1 of the piston (partition member) 20, and the choke passage T2 can be formed in the piston (partition member) 20 without difficulty. Note that, as illustrated in FIG. 12, when the portion T2c of the choke passage T2 is disposed on the inner peripheral side of the extension side ports (ports) 21b of the piston 20, the extension side ports (ports) 21b may be provided with the bent portions 21b1 bent toward the outer peripheral side of the piston (partition member) 20, and the portion T2c of the choke passage T2 disposed on the inner peripheral side of the extension side ports (ports) 21b and passing along the circumferential direction may be disposed on the inner peripheral side of the bent portions 21b1 of the extension side ports (ports) 21b of the piston (partition member) 20 and on the side opposite to the bent side of the bent portions 21b1. With the shock absorber D configured as described above, a space for providing the portion T2c passing through the inner periphery of the extension side ports (ports) 21b of the piston 20 along the circumferential direction of the choke passage T2 is formed on the inner peripheral side of the bent portions 21b1 of the piston 20, and the choke passage T2 can be formed in the piston 20 without difficulty.

Furthermore, the piston (partition member) 20 of the third modification described above includes the small-diameter portion 25 that forms the annular gap C facing the extension side chamber (one working chamber) R1 with respect to the cylinder 1 on the outer periphery of the extension side chamber side end that is one end, and the choke passage T2 opens from the small-diameter portion 25 and reaches the compression side chamber side end that is the other end of the piston (partition member) 20. In the piston (partition member) 20 configured as described above, the outlet end of the choke passage T2 on the extension side chamber R1 side is formed in the small-diameter portion 25 that is an outer peripheral side portion of the piston (partition member) 20, and it is not necessary to provide the outlet end of the choke passage T2 on the extension side chamber R1 side at an end portion of the piston (partition member) 20 facing the extension side chamber (one working chamber) R1. Accordingly, the outlet ends of the compression side ports (ports) 21c can be disposed on the outer peripheral side of the end portion of the piston (partition member) 20 facing the extension side chamber (one working chamber) R1 without being interfered with by the choke passage T2. Therefore, with the shock absorber D configured as described above, since the diameter of the compression side annular valve seat 21f surrounding the compression side ports (ports) 21c formed in the piston (partition member) 20 can be secured to be large, the pressure receiving area of the compression side leaf valve 8 receiving the pressure of the compression side chamber R2 increases, and the valve opening responsiveness of the leaf valve 8 is improved. Therefore, with the shock absorber D configured as described above, since the valve opening responsiveness of the leaf valve 8 can be improved, variations in damping force characteristic for each product can be reduced.

Note that the small-diameter portion may be provided on the outer periphery on the piston 20 on the compression side chamber side, and in this case, it is sufficient if the extension side port 21b are disposed on the outer peripheral side of the compression side ports 21c and the extension side chamber side end of the choke passage T2 is opened to the small-diameter portion. In this way, when the outlet ends of the extension side ports 21b are formed on the outer peripheral side of the piston 20, the choke passage T2 does not become interference, and the diameter of the extension side annular valve seat 21d surrounding the extension side ports 21b can be increased to improve the valve opening responsiveness of the leaf valve 7, and variations in damping force characteristic of the shock absorber D for each product can be reduced.

Furthermore, the piston (partition member) 20 of the fourth modification described above includes the plurality of compression side ports (ports) 21c that allows the flow of the fluid from the compression side chamber R2 to the extension side chamber R1, and the plurality of extension side ports (second ports) 21b that is provided at positions on the inner peripheral side of the compression side ports (ports) 21c of the piston (partition member) 20 and not facing the compression side ports (ports) 21c in the radial direction and allows the flow of the fluid from the extension side chamber R1 to the compression side chamber R2, and one end of the choke passage T2 is connected to one of the compression side ports (ports) 21c, and the other end of the choke passage T2 is connected to one of the extension side ports (second ports) 21b. In the piston (partition member) 20 configured as described above, since the outlet ends at both ends of the choke passage T2 are not formed at the extension side chamber side end and the compression side chamber side end of the piston (partition member) 20, the diameter of the compression side annular valve seat 21f surrounding the compression side ports (ports) 21c and the diameter of the extension side annular valve seat 21d surrounding the extension side ports 21b can be increased. Therefore, with the shock absorber D configured as described above, the valve opening responsiveness of the leaf valves 7 and 8 can be improved, and variations in damping force characteristic of the shock absorber D for each product can be reduced. Note that, in the first embodiment, the compression side ports 21c are ports, and the extension side ports 21b are second ports, but the compression side ports 21c may be second ports, and the extension side ports 21b may be ports.

### Second Embodiment

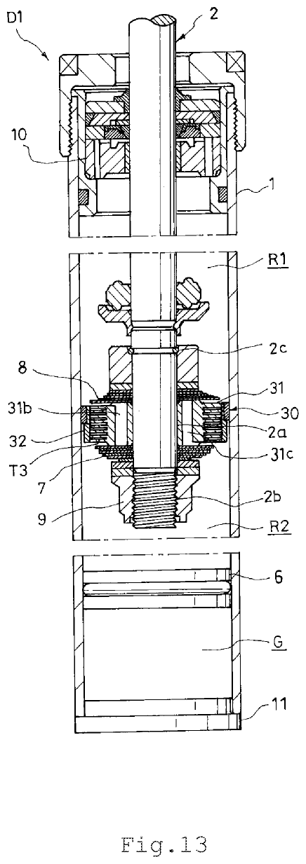

As illustrated in FIG. 13, a shock absorber D1 according to the second embodiment includes a cylinder 1, a rod 2 movably inserted into the cylinder 1, and a piston 30, which is a partition member, that is inserted into the cylinder 1 and defines an extension side chamber R1 and a compression side chamber R2 as two working chambers in the cylinder 1. Further, similarly to the shock absorber D, the shock absorber D1 is used by being interposed between a vehicle body and an axle of a vehicle, which is not illustrated, to suppress vibrations of the vehicle body and the wheels. Note that, among the members constituting the shock absorber D1 of the second embodiment, the same members as the members constituting the shock absorber D of the first embodiment are denoted by the same reference numerals as the members of the shock absorber D of the first embodiment.

Each part of the shock absorber D1 will be described in detail below. As illustrated in FIG. 13, a rod guide 10 having an annular shape is mounted on an upper end of the cylinder 1, and a lower end of the cylinder 1 is closed by a cap 11. Further, in the cylinder 1, the rod 2 on which the piston 30 is mounted at a distal end is movably inserted.

The rod 2 is slidably inserted into the rod guide and inserted into the cylinder 1, and movement in the axial direction is guided by the rod guide 10. In addition, the inside of the cylinder 1 is partitioned by the piston 30 into the extension side chamber R1 and the compression side chamber R2 that are filled with fluid such as hydraulic fluid. Note that a liquid other than the hydraulic fluid such as water and an aqueous solution may also be used as the fluid. In addition, the fluid may be a gas instead of a liquid.

Note that a gas chamber G is defined inside the cylinder 1 below the compression side chamber R2 by a free piston 6 slidably inserted into the cylinder 1. Further, when the rod 2 is displaced in the axial direction with respect to the cylinder 1, the gas chamber G is expanded or contracted by the free piston 6 being displaced in the axial direction with respect to the cylinder 1 according to the volume of the rod 2 entering and leaving the cylinder 1, and the volume of the rod 2 entering and leaving the cylinder 1 is compensated by a change in the volume of the gas chamber G. In this manner, the shock absorber D1 is a so-called single cylinder type shock absorber, but may be configured as a double cylinder type shock absorber including a reservoir outside the cylinder 1.

Returning to this, the rod 2 includes a screw portion 2b provided on the outer periphery of a distal end portion 2a, which is a lower end in FIG. 13, and a C-ring 2c attached to the outer periphery above the distal end portion 2a. An extension side leaf valve 7 and a compression side leaf valve 8 formed in an annular shape are attached to the outer periphery of the distal end portion 2a of the rod 2 together with the piston 30 having an annular shape. The leaf valves 7 and 8 and the piston 30 are sandwiched between a piston nut 9 screwed to the screw portion 2b and the C-ring 2c and fixed to the outer periphery of the distal end portion 2a of the rod 2.

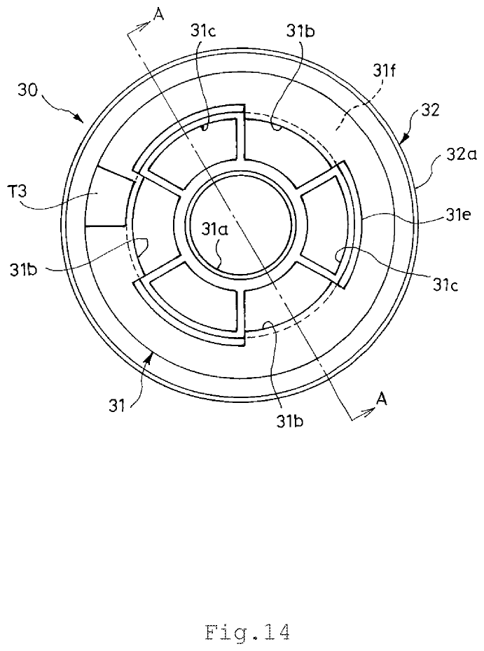

As illustrated in FIGS. 14 to 16, the piston 30 includes a first member 31 having an annular shape and a second member 32 having an annular shape fitted to the outer periphery of the first member 31. The first member 31 has a disk shape, and includes an insertion hole 31a through which the distal end portion 2a of the rod 2 is inserted at the center, and extension side ports 31b and compression side ports 31c that are provided on the same circumference and have an arc shape as viewed in the axial direction. In addition, three extension side ports 31b and three compression side ports 31c are alternately arranged on the same circumference in the first member 31, and serve as ports in the piston 30, which is a partition member.

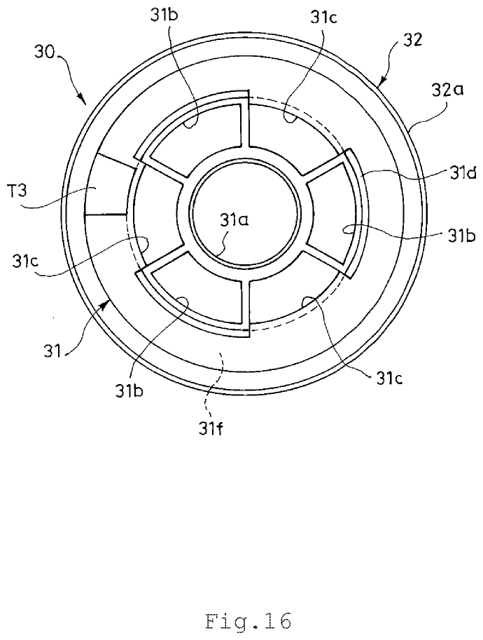

In addition, the first member 31 includes a valve seat 31d having a petal shape surrounding each extension side port 31b at an end portion facing the compression side chamber R2 side as illustrated in FIG. 16 and a valve seat 31e having a petal shape surrounding each compression side port 31c at an end portion facing the extension side chamber R1 side as illustrated in FIG. 14. As described above, the extension side ports 31b provided in the piston 30 of the shock absorber D1 of the second embodiment are independent opening ports that do not communicate with each other, and the compression side ports 31c are also independent opening ports that do not communicate with each other.

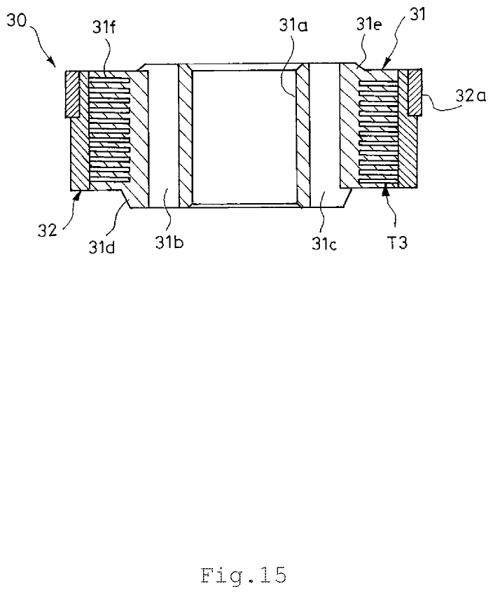

Further, as illustrated in FIGS. 14 to 16, the first member 31 includes a groove 31f having a spiral shape along the circumferential direction on the outer periphery that is a facing peripheral portion facing the second member 32. The groove 31f opens from the extension side chamber R1 side end of the first member 31, which is an upper end in FIG. 15, goes around the outer periphery of the first member 31 in a spiral shape, and opens to the compression side chamber R2 side end of the first member 31, which is a lower end in FIG. 15. The groove 31f is formed so as not to come into contact with the extension side ports 31b and the compression side ports 31c in a state where the entirety is opened to the outside in the thick portion of the outer periphery of the extension side ports 31b and the compression side ports 31c of the first member 31.

On the other hand, as illustrated in FIG. 15, the second member 32 includes a piston ring 32a having an annular shape on the outer periphery. Further, when the second member 32 is fitted to the outer periphery of the first member 31, the inner peripheral surface faces the groove 31f while leaving the outlet end of the groove 31f on the extension side chamber R1 side and the outlet end on the compression side chamber R2 side. Therefore, when the second member 32 is fitted to the outer periphery of the first member 31, the groove 31f forms a choke passage T3 having a spiral shape in which only both ends are opened.

That is, when the piston 30, which is a partition member, is assembled by fitting the first member 31 to the inner periphery of the second member 32, the choke passage T3 is formed by the groove 31f. The choke passage T3 has a spiral shape and opens from the outer peripheral side of the valve seat 31e at the extension side chamber R1 side end of the piston 30 to the outer peripheral side of the valve seat 31d at the compression side chamber R2 side end of the piston 30 and communicates the extension side chamber R1 and the compression side chamber R2.

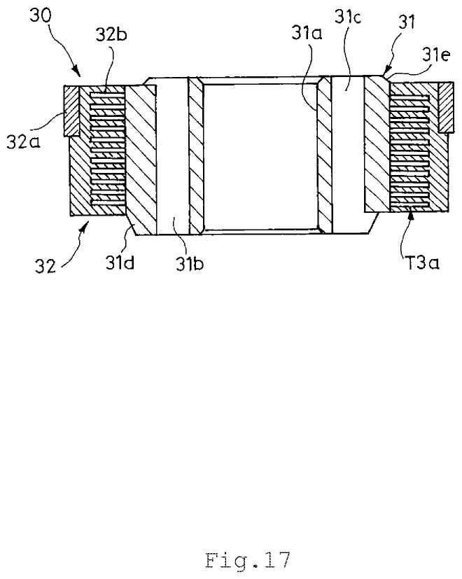

Note that, like a piston 30 of the first modification illustrated in FIG. 17, the groove 31f may not be provided in the outer periphery of the first member 31, but a groove 32b may be formed in the inner periphery of the second member 32 that is a facing peripheral portion facing the first member 31. Also in this case, when the second member 32 is fitted to the first member 31, a choke passage T3a is formed by the groove 32b.

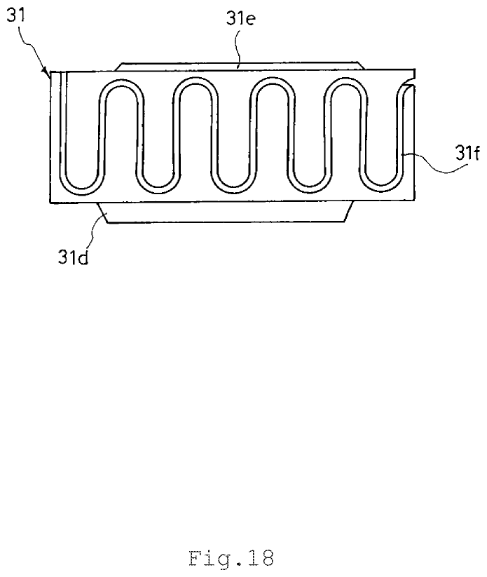

In addition, although not illustrated, the choke passage T3 may have a shape having a spiral portion partway. That is, the choke passage T3 may be formed by a spiral portion, a portion that opens in the axial direction from the outer peripheral side of the valve seat 31e at the extension side chamber R1 side end of the piston 30 and is connected to the spiral portion, and a portion that opens in the axial direction from the outer peripheral side of the valve seat 31d at the compression side chamber R2 side end of the piston 30 and is connected to the spiral portion. As described above, the extending direction and the cross-sectional shape of choke passage T3 can be arbitrarily set by the extending direction and the cross-sectional shape of the groove 31f. Accordingly, the groove 31f may have a shape meandering in the axial direction of the first member 31 and extending along the circumferential direction as in a piston 30 of the second modification illustrated in FIG. 18.

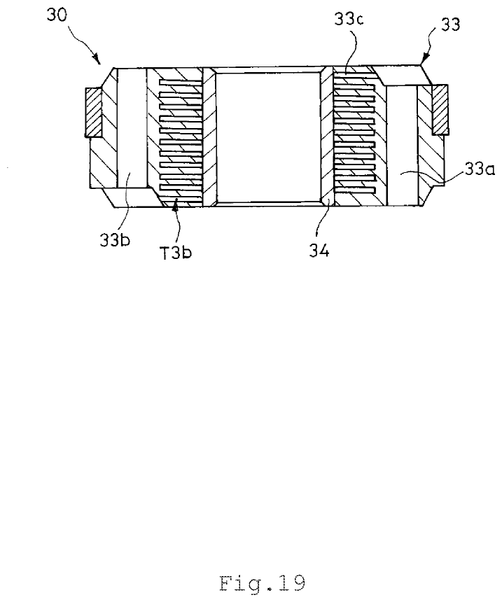

In addition, as in a piston 30 of the third modification illustrated in FIG. 19, as a structure in which a second member 34 is fitted to the inner periphery of a first member 33, a groove 33c may be formed in the inner periphery of the first member 33 using the inner periphery of the first member 33 having extension side ports 33a and compression side ports 33b as a facing peripheral portion. In this case, the second member 34 is attached to the distal end portion 2a of the rod 2, and the first member 33 is brought into sliding contact with the cylinder 1. The groove 33c has one end connected to one of the extension side ports 33a and the other end connected to one of the compression side ports 33b, and communicates the extension side chamber R1 and the compression side chamber R2 via the extension side port 33a and the compression side port 33b. Even when the groove 33c is formed in the inner periphery of the first member 33 as described above, when the second member 34 is fitted to the first member 33, a choke passage T3b is formed by the groove 33c. Note that when the choke passage T3b is disposed on the inner peripheral side of the extension side ports 33a and the compression side ports 33b of the piston 30 as described above, instead of forming the groove 33c in the inner periphery of the first member 33, a groove for forming the choke passage may be provided using the outer periphery of the second member 34 as a facing peripheral portion.

Note that the piston 30 configured as described above includes the two parts: the first member 31, 33 and the second member 32, 34, and the groove 31f, 32b, 33c is formed in the facing peripheral portion that is a peripheral surface facing the counterpart of the first member 31, 33 or the second member 32, 34, so that the groove 31f, 32b, 33c having a shape along the circumferential direction can be processed from the outside. In addition, when the groove is provided using the outer periphery of the first member 31, 33 or the second member 32, 34 as a facing peripheral portion, the first member 31, 33 or the second member 32, 34 can be manufactured by sintering using a mold although depending on the shape of the groove. Therefore, in the shock absorber D1 of the second embodiment, the choke passage T3, T3a, T3b can be easily provided inside the piston 30. In addition, a 3D printer may be used in manufacturing the piston 30. By using a 3D printer, the first member 31, 33 or the second member 32, 34 having the groove 31f, 32b, 33c that need to be processed through a plurality of processes can be manufactured by single processing.

The extension side leaf valve 7 is a stack leaf valve in which a plurality of annular plates is stacked, and is stacked on a lower surface of the piston 30 facing the compression side chamber R2 in FIG. 13. The inner periphery of the extension side leaf valve 7 is sandwiched and fixed between the piston nut 9 and the C-ring 2c, bending of the outer peripheral side, which is a free end, is allowed, and the extension side leaf valve 7 is seated and unseated with respect to the valve seat 31d to open and close outlet ends of the extension side ports 31b. As described above, when the extension side leaf valve 7 is placed on the piston 30, sandwiched between the piston nut 9 and the C-ring 2c of the rod 2, and fixed to the rod 2, the extension side leaf valve 7 abuts on the valve seat 31d and is stacked on the piston 30. Further, in a state where the outer periphery is seated on the valve seat 31d, the extension side leaf valve 7 closes the extension side ports 31b and disconnects communication between the extension side chamber R1 and the compression side chamber R2 via the extension side ports 31b. In addition, when the extension side leaf valve 7 is bent by receiving a pressure of the extension side chamber R1 through the extension side ports 31b and unseated from the valve seat 31d, the extension side ports 31b are opened, the extension side chamber R1 and the compression side chamber R2 communicate with each other, and resistance is applied to the flow of the hydraulic fluid from the extension side chamber R1 to the compression side chamber R2.

In addition, the compression side leaf valve 8 is a stack leaf valve in which a plurality of annular plates is stacked, and is stacked on an upper surface of the piston 30 facing the extension side chamber R1 in FIG. 13. The inner periphery of the compression side leaf valve 8 is sandwiched and fixed between the piston nut 9 and the C-ring 2c, bending of the outer peripheral side, which is a free end, is allowed, and the compression side leaf valve 8 is seated and unseated with respect to the valve seat 31e to open and close outlet ends of the compression side ports 31c. As described above, when the compression side leaf valve 8 is placed on the piston 30, sandwiched between the piston nut 9 and the C-ring 2c of the rod 2, and fixed to the rod 2, the compression side leaf valve 8 abuts on the valve seat 31e and is stacked on the piston 30. Further, in a state where the outer periphery is seated on the valve seat 3e, the compression side leaf valve 8 closes the compression side ports 31c and disconnects communication between the compression side chamber R2 and the extension side chamber R1 via the compression side ports 31c. In addition, when the compression side leaf valve 8 is bent by receiving a pressure of the compression side chamber R2 through the compression side ports 31c and unseated from the valve seat 31e, the compression side ports 31c are opened, the compression side chamber R2 and the extension side chamber R1 communicate with each other, and resistance is applied to the flow of the hydraulic fluid from the compression side chamber R2 to the extension side chamber R1.

The shock absorber D1 is configured as described above, and the operation of the shock absorber D1 will be described hereinafter. First, an operation when the rod 2 moves upward in FIG. 13 with respect to the cylinder 1 and the shock absorber D1 performs an extension operation will be described. When the shock absorber D1 performs the extension operation, the piston 30 moves upward in FIG. 13 with respect to the cylinder 1, and thus, the extension side chamber R1 is compressed and the compression side chamber R2 is enlarged.

Then, the pressure in the extension side chamber R1 increases. This pressure acts on the extension side leaf valve 7 through the extension side ports 31b that are not closed by the leaf valve 8 stacked on the upper end of the piston 30 in FIG. 13. When the extension speed of the shock absorber D1 is low and the pressure in the extension side chamber R1 does not reach the valve opening pressure of the leaf valve 7, the hydraulic fluid moves from the extension side chamber R1 to the compression side chamber R2 only through the choke passage T3. Therefore, when the extension speed is low, the choke passage T3 applies resistance to the hydraulic fluid passing therethrough and the shock absorber D1 generates a damping force. In addition, when the extension speed of the shock absorber D1 exceeds the low speed and reaches the high speed range, the leaf valve 7 bends and is unseated from the valve seat 31d to open the extension side ports 31b, so that the hydraulic fluid in the extension side chamber R1 passes through the extension side ports 31b and the choke passage T3 and moves to the compression side chamber R2. When the flow rate increases, the choke passage T3 applies a larger resistance to the flow of the hydraulic fluid than the leaf valve 7 does. Therefore, when the extension speed of the shock absorber D1 becomes high, the hydraulic fluid is less likely to pass through the choke passage T3, so that the hydraulic fluid preferentially passes through the extension side ports 31b. Therefore, when the extension speed exceeds the low speed and reaches the high speed range, the shock absorber D1 generates a damping force substantially by the resistance applied to the flow of the hydraulic fluid by the leaf valve 7. Note that at the time of extension of the shock absorber D1, since the rod 2 is retracted from the inside of the cylinder 1, the free piston 6 moves upward in FIG. 13 with respect to the cylinder 1, the volume of the gas chamber G is enlarged by the volume of the rod 2 retracted from the inside of the cylinder 1, and the volume of the rod 2 retracted from the inside of the cylinder 1 is compensated.

Next, an operation when the rod 2 moves downward in FIG. 13 with respect to the cylinder 1 and the shock absorber D1 performs a contraction operation will be described. When the shock absorber D1 performs the contraction operation, the piston 30 moves downward in FIG. 13 with respect to the cylinder 1, and thus, the compression side chamber R2 is compressed, and the extension side chamber R1 is enlarged.

Then, the pressure in the compression side chamber R2 increases. This pressure acts on the compression side leaf valve 8 through the compression side ports 31c that are not closed by the leaf valve 7 stacked on the lower end of the piston 30 in FIG. 13. When the contraction speed of the shock absorber D1 is low and the pressure in the compression side chamber R2 does not reach the valve opening pressure of the leaf valve 8, the hydraulic fluid moves from the compression side chamber R2 to the extension side chamber R1 only through the choke passage T3. Therefore, when the contraction speed is low, the choke passage T3 applies resistance to the hydraulic fluid passing therethrough and the shock absorber D1 generates a damping force. In addition, when the contraction speed of the shock absorber D1 exceeds the low speed and reaches the high speed range, the leaf valve 8 bends and is unseated from the valve seat 31e to open the compression side ports 31c, so that the hydraulic fluid in the compression side chamber R2 passes through the compression side ports 31c and the choke passage T3 and moves to the extension side chamber R1. When the flow rate increases, the choke passage T3 applies a larger resistance to the flow of the hydraulic fluid than the leaf valve 8 does. Therefore, when the contraction speed of the shock absorber D1 becomes high, the hydraulic fluid is less likely to pass through the choke passage T3, so that the hydraulic fluid preferentially passes through the compression side ports 31c. Therefore, when the contraction speed exceeds the low speed and reaches the high speed range, the shock absorber D1 generates a damping force substantially by the resistance applied to the flow of the hydraulic fluid by the leaf valve 8. Note that at the time of contraction of the shock absorber D1, since the rod 2 enters the inside of the cylinder 1, the free piston 6 moves downward in FIG. 13 with respect to the cylinder 1, the volume of the gas chamber G is reduced by the volume of the rod 2 entering the inside of the cylinder 1, and the volume of the rod 2 entering the inside of the cylinder 1 is compensated.

As described above, when the extension and contraction speed of the shock absorber D1 is low, the shock absorber D1 generates a damping force with the choke passage T3, and when the extension and contraction speed of the shock absorber D1 is high, the shock absorber D1 generates a damping force with the leaf valves 7 and 8. Therefore, the damping force characteristic of the shock absorber D1 of the second embodiment is a characteristic that becomes the choke characteristic substantially proportional to the extension and contraction speed when the extension and contraction speed of the shock absorber D1 is low and changes to the valve characteristic of the leaf valves 7 and 8 when the extension and contraction speed of the shock absorber D1 is high.

As described above, the shock absorber D1 of the second embodiment includes the cylinder 1, the rod 2 movably inserted into the cylinder 1, and the piston (partition member) 30 that has a disk shape and is inserted into the cylinder 1 to partition the inside of the cylinder 1 into the extension side chamber R1 and the compression side chamber R2 as the two working chambers, and the piston (partition member) 30 includes the first member 31 that has an annular shape and has the extension side ports (ports) 31b and the compression side ports (ports) 31c that communicate the extension side chamber R1 and the compression side chamber R2, and the second member 32 that has an annular shape and is fitted to the inner periphery or the outer periphery of the first member 31, the first member 31 has the groove 31f formed along the circumferential direction in the outer periphery that is a facing peripheral portion facing the second member 32 and communicating the extension side chamber R1 and the compression side chamber R2, and the choke passage T3 is formed by the groove 31f by fitting the first member 31 and the second member 32.

In the shock absorber D1 configured as described above, since the choke passage T3 is provided along the circumferential direction in a dead space on the outer peripheral side of the extension side ports (ports) 31b and the compression side ports (ports) 31c of the piston (partition member) 30 having a disk shape, the passage length of the choke passage T3 can be increased without increasing the axial length of the piston (partition member) 30. Since the passage length of the choke passage T3 can be increased, the degree of freedom in designing the passage length of the choke passage T3 is improved, and the choke passage T3 having a sufficient length can be formed in the piston (partition member) 30. As described above, with the shock absorber D1 of the second embodiment, the passage length of the choke passage T3 can be increased, and it is not necessary to use an orifice the damping force characteristic of which is difficult to set as a countermeasure for the insufficient damping force, and therefore, the damping force at the time of extension and contraction at a low speed can be increased, and the damping force characteristic can be easily set.

In addition, since the choke passage T3 is formed by the groove 31f provided in the outer periphery of the first member 31, the piston (partition member) 30 having the choke passage T3 having a complicated shape can be manufactured by simple processing.

Note that, as described above, it is sufficient if the groove forming the choke passage T3 is provided in the facing peripheral portion of any one of the first member 31 and the second member 32, and therefore, the groove may be provided in the inner periphery of the second member 32, and in the case of a structure in which the second member 34 is fitted to the inner periphery of the first member 33, the groove may be provided in the inner periphery of the first member or the outer periphery of the second member 34.

In addition, with the shock absorber D1 of the second embodiment, since the choke passage T3 is formed by the groove 31f, 33c, 34b having a spiral shape provided in the outer periphery of the first member 31, the inner periphery of the first member 33, the inner periphery of the second member 32, or the outer periphery of the second member 34, the length of the choke passage T3 can be set by setting the number of times of circulating the inside of the piston (partition member) 30 in the circumferential direction by effectively using the dead space of the piston (partition member) 30, and the degree of freedom in designing the passage length of the choke passage T3 can be greatly improved.

Furthermore, as in the piston 30 of the second modification, the choke passage T3 may be formed by the groove 31f formed to meander in the axial direction of the piston (partition member) 30 and extend in the circumferential direction with respect to the outer periphery that is the facing peripheral portion of the first member 31. Also in the shock absorber D1 configured as described above, the length of the choke passage T3 can be set by setting the number of times of meandering the inside of the piston (partition member) 30 in the axial direction by effectively using the dead space of the piston (partition member) 30, and the degree of freedom in designing the passage length of the choke passage T3 can be greatly improved. Note that also when the choke passage T3 is formed by such a meandering groove, it is sufficient if the groove is provided in the inner periphery of the first member 33, the inner periphery of the second member 32, or the outer periphery of the second member 34 in addition to the outer periphery of the first member 31.

Note that, in the shock absorber D1 of the second embodiment, the partition member is the piston 30, but a partition wall or the like used in a manner of being fixed to the cylinder 1 may be used as the partition member. For example, in a double cylinder type shock absorber including a reservoir outside the cylinder, a valve case fixed to an end portion of the cylinder may be used as a partition member, the reservoir and a compression side chamber partitioned by the valve case may be used as working chambers, and a choke passage may be formed in the valve case.

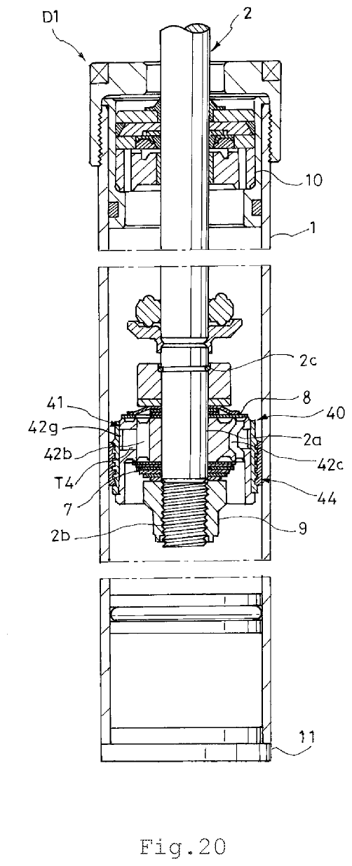

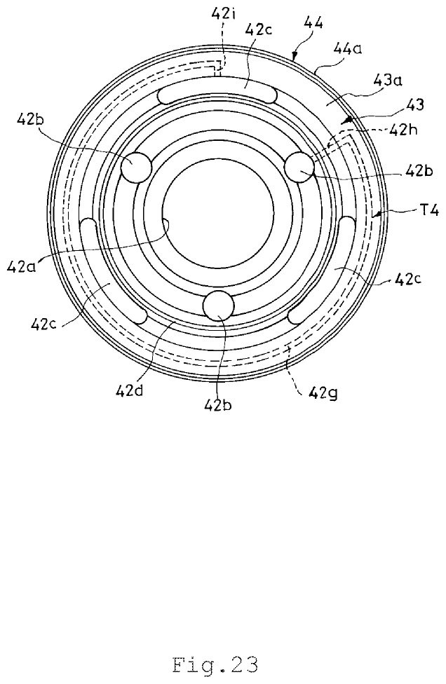

In addition, as illustrated in FIG. 20, a piston 40 may be configured as described below as a fourth modification of the partition member. As illustrated in FIGS. 20 to 23, the piston 40 is configured to include a first member 41 and a second member 44 fitted to the outer periphery of the first member 41.

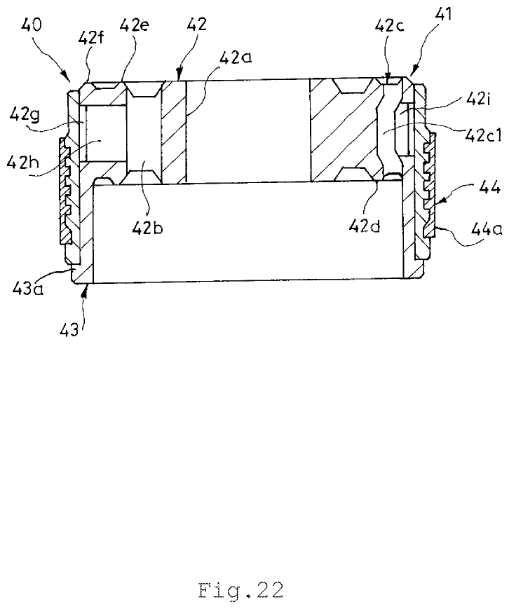

The first member 41 includes a main body portion 42 having a disk shape and including an insertion hole 42a that allows insertion of the rod 2 at the center, and an extension portion 43 having a cylindrical shape suspended from the outer periphery of the lower end of the main body portion 42 in FIG. 22. In addition, the main body portion 42 includes three compression side ports 42c, which are ports, that communicate the extension side chamber R1 and the compression side chamber R2 and have an arc shape as viewed in the axial direction, and three extension side ports 42b, which are third ports, that communicate the extension side chamber R1 and the compression side chamber R2 and have a circular shape as viewed in the axial direction. The extension side ports 42b are provided at equal intervals on the same circumference of the main body portion 42, and the compression side ports 42c are provided at equal intervals on the same circumference on the outer peripheral side of the extension side ports 21b of the main body portion 42. Further, an extension side annular valve seat 42d surrounding the outer peripheral side of the extension side ports 42b is provided at the compression side chamber R2 side end of the main body portion 42, and an inner annular valve seat 42e provided between the extension side ports 42b and the compression side ports 42c and surrounding the extension side ports 42b and a compression side annular valve seat 42f surrounding the outer periphery of the compression side ports 42c are provided at the extension side chamber R1 side end of the main body portion 42.

The extension side ports 42b and the compression side ports 42c are provided at positions displaced from each other in the circumferential direction with respect to the main body portion 42, that is, at positions not aligned in a radial direction with respect to the main body portion 42. Furthermore, as illustrated in FIG. 22, the compression side port 42c provided on the outer peripheral side of the main body portion 42 includes a bent portion 42c1 bent toward the inner peripheral side of the first member 41 at the center. In addition, the extension portion 43 includes a flange portion 43a having a cylindrical shape, suspended from the outer periphery of the lower end of the main body portion 42, and protruding toward the outer peripheral side at the lower end. The outer diameter of the extension portion 43 is set to be the same diameter as that of the main body portion 42 except for the flange portion 43a, and the outer periphery of the extension portion 43 and the outer periphery of the main body portion 42 are flush with each other. The second member 44 having an annular shape is fitted from the upper end of the main body portion 42 of the first member 41 configured as described above in FIG. 22 to the upper side of the flange portion 43a of the extension portion 43.

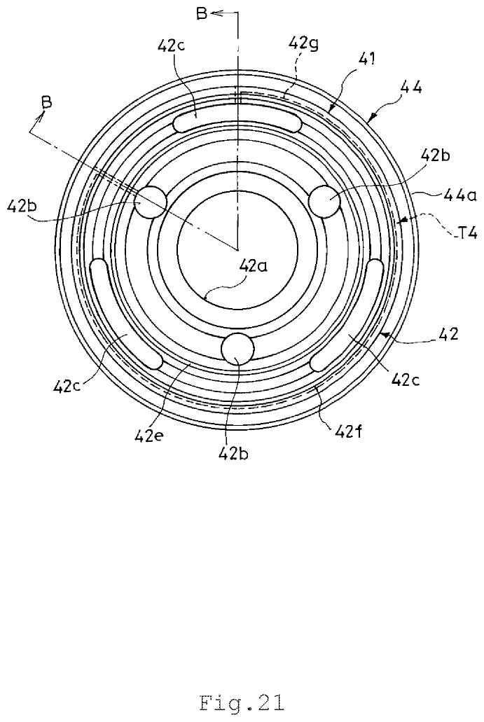

Further, in addition, a groove 42g is provided on the outer periphery that is a facing peripheral portion of the main body portion 42 of the first member 41 facing the second member 44. The groove 42g is provided along the circumferential direction on the outer periphery of the main body portion 42 of the first member 41. One end of the groove 42g is connected to the extension side port 42b through a hole 42h extending in the radial direction through the wall of the main body portion 42, and the other end of the groove 42g is connected to the compression side port 42c through a hole 42i extending in the radial direction through the wall of the first member 41. Therefore, the groove 42g communicates the extension side chamber R1 and the compression side chamber R2 via the extension side port 42b and the compression side port 42c. In addition, the groove 42g passes through the outside of the bent portions 42cl of the compression side ports 42c, and as illustrated in FIG. 21, the groove is disposed at a position passing through the vicinity of the open ends of the compression side ports 42c when the piston 40 is viewed from the axial direction.

On the other hand, as illustrated in FIG. 22, the second member 44 includes a piston ring 44a having an annular shape on the outer periphery. Further, when the second member 44 is fitted to the outer periphery of the first member 41, the inner peripheral surface faces the groove 42g. Therefore, when the second member 44 is fitted to the outer periphery of the first member 41, the groove 42g is closed by the second member 44, and a choke passage T4 that communicates the extension side chamber R1 and the compression side chamber R2 through the extension side port 42b and the compression side port 42c is formed.

The choke passage T4 thus formed is disposed in the outer periphery of the bent portions 42c1 of the compression side ports 42c and on the side opposite to the bent side of the bent portions 42c1, and is disposed between the openings of the compression side ports 42c on the extension side chamber R1 side and the openings on the compression side chamber R2 side in the axial direction of the piston 40. From the viewpoint of the compression side ports 42c, the compression side ports 42c include the bent portions 42cl that avoid the groove 42g forming the choke passage T4 at the center.

The compression side ports 42c include the bent portions 42c1 partway as described above, and a space for providing the groove 42g is formed in the outer periphery of the bent portions 42c1, and the choke passage T4 can be formed in the piston 40 without difficulty. Note that since each extension side port 42b is provided on the inner peripheral side of each compression side port 42c of the piston 40, it is not necessary to provide a bent portion in order to secure a space for providing the groove 42g. Note that when a space for providing the groove 42g forming the choke passage T4 cannot be secured in the piston 30 without the bent portions because the compression side ports 42c and the extension side ports 42b are provided on the same circumference, the compression side ports 42c and the extension side ports 42b may be provided with the bent portions.

Note that, although not illustrated, when the second member 44 is fitted to the inner periphery of the first member 41, the groove forming the choke passage T4 may be formed not in the outer periphery but in the inner periphery of the first member 41. In this case, it is sufficient if a space for forming the groove is secured in the inner periphery of the first member 41 by providing the bent portions that bend toward the outer peripheral side of the first member 41 using the extension side ports 42b on the inner peripheral side as ports and the compression side ports 42c on the outer peripheral side are third ports.

Even when the choke passage T4 is formed in the piston 40 as described above, since the choke passage T4 is formed by the groove 42g provided in the inner periphery or the outer periphery of the first member 41, the choke passage T4 is provided along the circumferential direction in a dead space on the outer peripheral side or the inner peripheral side of the extension side ports (ports) 42b and the compression side ports (ports) 42c of the piston (partition member) 40. Therefore, the passage length of the choke passage T4 can be increased without increasing the axial length of the piston (partition member) 40.

Since the passage length of the choke passage T4 can be increased, the degree of freedom in designing the passage length of the choke passage T4 is improved, and the choke passage T4 having a sufficient length can be formed in the piston (partition member) 40. Therefore, with the shock absorber D1 of the second embodiment in which the choke passage T4 is formed in the piston 40 as described above, the passage length of the choke passage T4 can be increased, and it is not necessary to use an orifice the damping force characteristic of which is difficult to set as a countermeasure for the insufficient damping force, and therefore, the damping force at the time of extension and contraction at a low speed can be increased, and the damping force characteristic can be easily set.

In addition, in the piston (partition member) 40 of the fourth modification described above, the compression side ports (ports) 42c include the bent portions 42c1 that bend to the inner peripheral side of the first member 41, and the groove 42g forming the choke passage T4 is disposed in the outer periphery of the bent portions 42c1 of the compression side ports (ports) 42c of the first member 41 and on the side opposite to the bent side of the bent portions 42c1. With the shock absorber D1 configured as described above, a space for providing the choke passage T4 on the outer periphery is formed by the bent portions 42c1 of the first member 41, and the choke passage T4 can be formed in the piston (partition member) 40 without difficulty.

Furthermore, the first member 41 of the piston (partition member) 40 of the fourth modification described above includes the plurality of compression side ports (ports) 42c that allows the flow of the fluid from the compression side chamber R2 to the extension side chamber R1, and the plurality of extension side ports (third ports) 42b that is provided at positions on the inner peripheral side of the compression side ports (ports) 42c of the piston (partition member) 40 and not facing the compression side ports (ports) 42c in the radial direction and allows the flow of the fluid from the extension side chamber R1 to the compression side chamber R2, the groove 42g is formed in the first member 41, and one end of the choke passage T4 is connected to one of the compression side ports (ports) 42c, and the other end of the choke passage T4 is connected to one of the extension side ports (third ports) 42b. In the piston (partition member) 40 configured as described above, since the outlet ends at both ends of the choke passage T4 are not formed at the extension side chamber side end and the compression side chamber side end of the piston (partition member) 40, the diameter of the compression side annular valve seat 42f surrounding the compression side ports (ports) 42c and the diameter of the extension side annular valve seat 42d surrounding the extension side ports 42b can be increased. Therefore, with the shock absorber D1 configured as described above, the valve opening responsiveness of the leaf valves 7 and 8 can be improved, and variations in damping force characteristic of the shock absorber D1 for each product can be reduced. Note that, in the second embodiment, the compression side ports 42c are ports, and the extension side ports 42b are third ports, but the compression side ports 42c may be third ports, and the extension side ports 42b may be ports.

Although the preferred embodiments of the present invention have been described above in detail, modifications, variations, and changes can be made without departing from the scope of the claims.

The present application claims priority based on Japanese Patent Application No. 2021-020665 and Japanese Patent Application No. 2021-020667 filed with the Japan Patent Office on Feb. 12, 2021, and the entire contents of the applications are incorporated into the present specification by reference.

1. A shock absorber comprising:
a cylinder;
a rod that is movably inserted into the cylinder; and
a partition member that has a disk shape and is inserted into the cylinder to define two working chambers in the cylinder,
wherein
the partition member includes ports communicating the two working chambers, and a choke passage having a portion communicating the two working chambers and passing through an inner peripheral side or an outer peripheral side of the ports of the partition member along a circumferential direction.

2. The shock absorber according to claim 1, wherein
the partition member includes
a first member that has an annular shape and has ports communicating the two working chambers, and
a second member that has an annular shape and is fitted to an inner periphery or an outer periphery of the first member,
one of the first member and the second member has a groove formed along a circumferential direction in a facing peripheral portion facing an other of the first member and
the second member and communicating the working chambers with each other, and
a choke passage is formed by the groove by fitting the first member and the second member.

3. The shock absorber according to claim 1, wherein
the portion of the choke passage has a spiral shape and is disposed on the inner peripheral side or the outer peripheral side of the ports of the partition member.

4. The shock absorber according to claim 1, wherein
the ports have bent portions bent toward one of an inner periphery and an outer periphery of the partition member, and
the portion of the choke passage is disposed on the inner peripheral side or the outer peripheral side of the bent portion of each of the ports of the partition member and on a side opposite to a bent side of the bent portion.

5. The shock absorber according to claim 1, wherein
the partition member has a small-diameter portion forming an annular gap facing one of the working chambers with respect to the cylinder on an outer periphery at one end, and
the choke passage opens from the small-diameter portion and reaches an other end of the partition member.

6. The shock absorber according to claim 1, wherein
the partition member includes a plurality of the ports that allows a flow of fluid from one of the working chambers toward an other of the working chambers, and a plurality of second ports that is provided on an inner peripheral side of each of the ports of the partition member and at positions not aligned with each of the ports in a radial direction and allows a flow of fluid from the other of the working chambers toward the one of the working chambers, and one end of the choke passage is connected to one of the ports, and an other end of the choke passage is connected to one of each of the second ports.

7. The shock absorber according to claim 2, wherein
the groove is provided in a spiral shape along the circumferential direction in the facing peripheral portion.

8. The shock absorber according to claim 2, wherein
the groove is formed so as to meander in an axial direction of the partition member with respect to the facing peripheral portion and extend in the circumferential direction.

9. The shock absorber according to claim 2, wherein
the ports have bent portions bent toward one of an inner periphery and an outer periphery of the first member, and the groove is disposed in an inner periphery or an outer periphery of the bent portions of the ports of the first member and on a side opposite to a bent side of the bent portions.

10. The shock absorber according to claim 2, wherein
the first member includes a plurality of the ports that allows a flow of fluid from one of the working chambers toward an other of the working chambers, and a plurality of third ports that is provided on an inner peripheral side of each of the ports of the first member and at positions not aligned with each of the ports in a radial direction and allows a flow of fluid from the other of the working chambers toward the one of the working chambers,
the groove is formed in the first member, and
one end of the choke passage is connected to one of each of the ports, and an other end of the choke passage is connected to one of each of the third ports.
